(19) United States
(12) Patent Application Publication
(10) Pub. No.: US 2012/0215764 A1
(43) Pub. Date: Aug. 23, 2012

(54) ENERGY USAGE AND PERFORMANCE QUERY GOVERNOR

(75) Inventors: Eric L. Barsness, Pine Island, MN (US); John M. Santosuosso, Rochester, MN (US)

(73) Assignee: INTERNATIONAL BUSINESS MACHINES CORPORATION, Armonk, NY (US)

(21) Appl. No.: 13/029,201

(22) Filed: Feb. 17, 2011

(51) Int. Cl. G06F 17/30

(52) U.S. Cl. 707/720; 707/E17.017

(57) ABSTRACT

Techniques are described for managing query execution using additional performance capabilities from a set of system resources. Embodiments may receive a query and calculate a first estimated execution time for processing the query using a first amount of performance capabilities from a first set of system resources. If embodiments determine that the first estimated execution time exceeds a threshold amount of time, a second estimated execution time is then calculated for processing the query using a second amount of performance capabilities from the first set of system resources. Here, the second amount of performance capabilities is in addition to the first amount of performance capabilities. If the second estimated execution time does not exceed the threshold amount of time, the query is executed using the second amount of performance capabilities from the first set of system resources.

### BACKGROUND

The present invention generally relates to database management, and more particularly, to managing query execution using a query governor.

Databases are computerized information storage and retrieval systems. A relational database management system is a computer database management system (DBMS) that uses relational techniques for storing and retrieving data. An object-oriented programming database is a database that is congruent with the data defined in object classes and subclasses.

Regardless of the particular architecture, a requesting entity (e.g., an application or the operating system) in a DBMS requests access to a specified database by issuing a database access request. Such requests may include, for instance, simple catalog lookup requests or transactions and combinations of transactions that operate to read, change and add specified records in the database. These requests (i.e., queries) are often made using high-level query languages such as the Structured Query Language (SQL). Upon receiving such a request, the DBMS may execute the request against a corresponding database, and return any result of the execution to the requesting entity.

As databases grow in size and in workload, particular queries or requests may take a substantial amount of time and resources to execute. As such, database administrators may wish to control how long queries on a database system may execute.

### SUMMARY

Embodiments of the invention provide a method, system and product for managing query execution. The method, system and product include calculating a first estimated execution time for processing a query using a first amount of performance capabilities from a first set of system resources. Upon determining that the first estimated execution time exceeds a threshold amount of time, a second estimated execution time for processing the query using a second amount of performance capabilities from the first set of system resources is calculated. Such a second amount performance capabilities is in addition to the first amount of performance capabilities. The method, system and product further include, upon determining that the second estimated execution time does not exceed the threshold amount of time, executing the query using the second amount of performance capabilities from the first set of system resources.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIGS. 1A-1B are block diagrams illustrating systems configured to run a query governor, according to embodiments of the present invention.

FIGS. 2A-2B are graphs illustrating the effects of using additional performance capabilities from a set of system resources, according to embodiments of the present invention.

FIG. 3 is a flow diagram illustrating a method for managing query runtime, according to one embodiment of the present invention.

FIG. 4 is a timeline diagram illustrating the effects of using additional performance capabilities from a set of system resources on query runtime, according to one embodiment of the present invention.

### DETAILED DESCRIPTION

Since all computers have a limited amount of system resources for use in running programs, proper resource management is important to ensure that these limited resources are effectively utilized. To this end, in a database system, database administrators may wish to restrict how long a particular query may run when executed. That is, if executing a particular query would tie up system resources for an excessive amount of time, to the detriment of the execution other queries and tasks on the system, the database administrators may wish to reject the query for execution. Such a rejection may be definitive (e.g., a message may be returned to the requesting entity, explaining the query was denied for processing) or the execution may be delayed to another time (e.g., the system may process the query once system resources become idle). This ensures that no single database query may monopolize the resources of the system.

Often times, specific system resources are capable of providing additional performance, but are limited by power and thermal constraints. This is particularly true with computer processors. For example, a computer processor may typically operate at a frequency of 3.0 GHz, a frequency at which the power and thermal constraints on the computer system are satisfied. That is, the system is able to provide sufficient sustained power to the processor at this frequency and the processor may operate in a sustained fashion at this frequency without overheating. However, the processor may be capable of operating at higher frequencies for a limited period of time. For example, the frequency of the processor may be increased to 3.6 GHz for several minutes without overheating, after which the frequency may be reduced back to normal operating levels. One technique for providing such additional processing capabilities from an existing set of system resources is the EnergyScale technology for POWER6® and POWER7® microprocessor based systems by International Business Machines (“IBM”).

Embodiments of the invention may receive a query for processing and determine a first estimated execution time for processing the query using a first set of system resources. As an example, embodiments may estimate how long the received query would take to execute on the aforementioned processor running at the sustained rate of 3.0 GHz. Embodiments may then compare the first estimated execution time with a maximum allowable runtime for the query. If the first estimated execution time exceeds the maximum allowable runtime, embodiments may then calculate a second estimated execution time for processing the query using additional performance capabilities of the first set of system resources. By way of example, embodiments may estimate how long the received query would take to execute on the aforementioned processor running at the non-sustainable frequency of 3.6 GHz. Upon determining the second estimated execution time does not exceed the maximum allowable runtime for the query, embodiments may execute the query using the additional performance capabilities of the system resources. That is, continuing the example, embodiments may temporarily boost the frequency of the computer processor to 3.6 GHz until the query has completed processing. By doing this, embodiments of the invention help to maximize the performance of existing system resources and ensure that queries are processed within the maximum allowable runtime.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., a database management system or “DBMS”) or related data available in the cloud. For example, the DBMS could execute on a computing system in the cloud and receive queries pertaining to one or more databases managed by the DBMS. In such a case, a query governor 182 could monitor incoming queries and, for each query, calculate an estimated execution time for executing the query. The query governor 182 may also determine a maximum allowable runtime for the query, and may enable the usage of additional performance capabilities of existing system resources in processing the query based on the estimated execution time and the maximum allowable runtime for the query. Doing so allows a user to submit queries from any computing system attached to a network connected to the cloud (e.g., the Internet), and helps to ensure queries execute within the determined maximum allowable runtime.

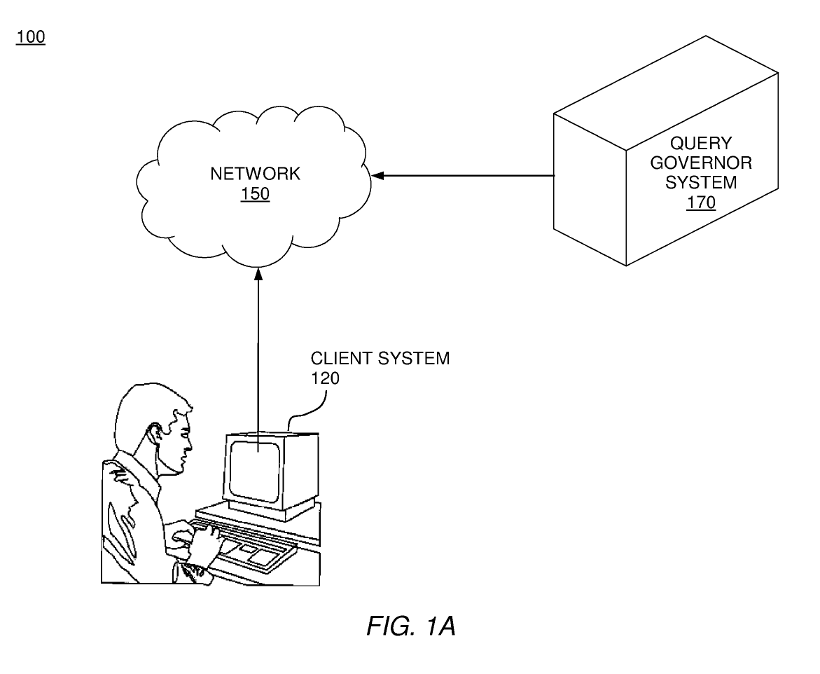

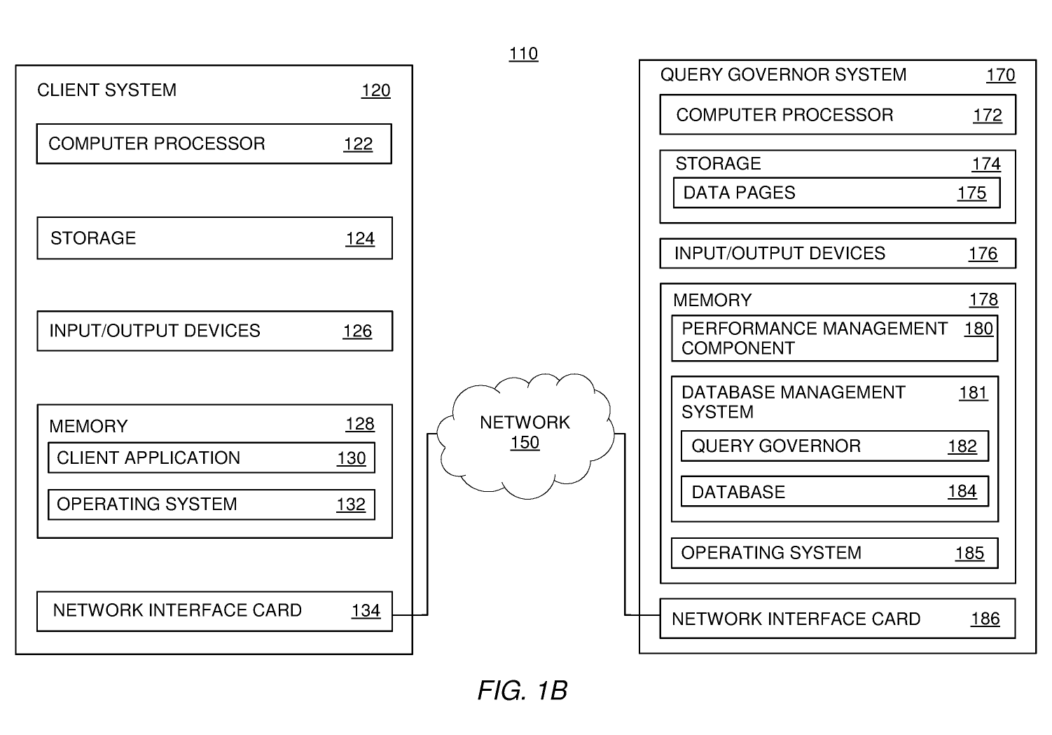

Referring now to FIGS. 1A-1B, FIGS. 1A-1B are block diagrams illustrating systems configured to run a query governor, according to embodiments of the present invention. More specifically, FIG. 1A is a block diagram illustrating a networked system for managing query execution using a query governor. As shown, the system 100 includes a client system 120 and a database server 170, connected by a network 150. Generally, the client system 120 may submit requests (i.e., queries) over the network 150 to a DBMS running on the database server 170. The term “query” denotes a set of commands for retrieving data from a stored database. Queries may take the form of a command language, such as the Structured Query Language (SQL), and enable programmers and programs to select, insert, update, and determine the location of data in the database.

Generally speaking, any requesting entity (i.e., different query types) can issue queries against data in a database. For example, software applications (such as by an application running on the client system 120), operating systems, and, at the highest level, users may submit queries to the database. These queries may be predefined (i.e., hard coded as part of an application) or may be generated in response to input (e.g., user input). Upon receiving the request, the DBMS on the database server 170 may execute the request on a database specified in the request, and then return a result of the executed request.

According to one embodiment of the invention, upon receiving a query for processing, a query governor on the query governor system 170 may calculate an estimated execution time for the received query. The estimated execution time generally reflects an amount of time it will take the DBMS to execute the received query. The query governor may calculate the estimated execution time using historical data collected from processing previous queries. As an example, assume that three previous queries containing SELECT statements for a particular database table took 15 seconds, 20 seconds and 25 seconds to execute. If the query governor system 170 then receives another query containing a SELECT statement for the particular database table, the query governor may estimate that the query will take 20 seconds to execute (i.e., the average of the three previous execution times).

Once the estimated execution time is calculated, the query governor may then determine a maximum allowable runtime (also referred to herein as a “threshold amount of time”) for the query. Generally, the maximum allowable runtime specifies a maximum (threshold) amount of the time that the query should finish executing within. In one embodiment, the user or application submitting the query may specify the maximum allowable runtime as part of the query. For example, the query may include a SQL tag specifying the maximum allowable runtime. In another embodiment, the query governor may retrieve the maximum allowable runtime associated with the query from one or more configuration files.

Upon determining the maximum allowable runtime for the query, the query governor may determine whether the estimated execution time for the query exceeds the maximum allowable runtime. If so, the query governor may calculate a second estimated execution time for executing the query using additional performance capabilities of the system resources of the query governor system 170. That is, as discussed above, certain system resources may be capable of operating with additional performance capabilities for a limited period of time. If the query governor determines that the query may be processed using the additional performance capabilities in less than the threshold amount of time, the DBMS may then execute the query using the additional performance capabilities. Once the query is executed, any results produced from executing the query may be returned to the requesting entity from which the query was received.

Advantageously, by doing this, embodiments of the invention may help to ensure that queries are processed on the database system within the maximum allowable runtime. By doing this, embodiments may better utilize all the processing capabilities of a set of system resources, and may do so in a way that allows particular queries to be executed within their corresponding maximum allowable runtime. Furthermore, embodiments of the invention may manage query execution in a way that avoids rejecting certain queries for processing that would otherwise be rejected. That is, existing query governors may reject a query for processing upon determining that the query may not be processed within a maximum allowable amount of time. In contrast, embodiments of the invention may still process such a query by enabling the additional performance capabilities of the existing system resources for use in processing the query more quickly. By doing this, embodiments help to ensure that queries are processed in an acceptable amount of time on the query governor system 170.

In one embodiment of the invention, the query governor may further calculate an estimated energy consumption for processing the query using the additional performance capabilities of the system resources. The query governor may then use the estimated energy consumption value in determining whether to execute the query using the additional performance capabilities. As an example, the query governor may determine that although the query governor could execute a particular query within the threshold amount of time using the additional performance capabilities, such additional performance capabilities would consume an excessive amount of energy. The query governor may then alter how it processes the query based on such a determination.

For instance, the query governor may determine that the query may be executed using a lesser amount of additional performance from the system resources. For instance, in an embodiment where the additional performance capabilities include overclocking one or more computer processors for a period of time, the query governor may determine that the processors should be overclocked to a lesser cycle rate (e.g., from 3.0 GHz to 3.3 GHz, instead of from 3.0 GHz to 3.6 GHz) in order to conserve energy. As a second example, the query governor may determine that the additional performance capabilities of the system resources should not be used at all in processing the particular query, based on the estimated energy consumption value. Of course, such examples are without limitation and for illustrative purposes only, and more generally, it is contemplated that the query governor may take any action consistent with the functions described herein, or may take no action at all, based on the estimated energy consumption value.

According to one embodiment of the invention, the query governor is further configured to predict a likelihood that the additional performance capabilities will be needed for processing subsequent queries within a period of time. As discussed above, although computing resources are often capable of operating at additional levels of performance, such additional performance is often sustainable only for limited periods of time. As such, the query governor may be configured to predict a likelihood that subsequent queries will use the additional performance capabilities of the system resources to execute within the threshold amount of time. As an example, assume that at 4:59 pm the query governor determines that a low priority query would need the additional performance capabilities to execute within the threshold amount of time, but that typically high priority queries are received at 5:00 pm which also would need the additional performance capabilities to execute within the threshold amount of time. In such a scenario, the query governor may avoid processing the low priority query using the additional performance capabilities of the system resources, since it is likely that the query governor will soon receive a high priority query for which the additional performance capabilities will need to be used.

FIG. 1B is a block diagram illustrating a system configured to run a query governor, according to one embodiment of the present invention. As shown, the system 110 contains the client system 120 and the database server 170. The client system 120 contains a computer processor 122, storage media 124, I/O devices 126, memory 128 and a network interface card 134. Computer processor 122 may be any processor capable of performing the functions described herein. The client system 120 may connect to the network 150 using the network interface card 134. Furthermore, as will be understood by one of ordinary skill in the art, any computer system capable of performing the functions described herein may be used.

Illustratively, memory 128 contains a client application 130 and an operating system 132. Although memory 128 is shown as a single entity, memory 128 may include one or more memory devices having blocks of memory associated with physical addresses, such as random access memory (RAM), read only memory (ROM), flash memory or other types of volatile and/or non-volatile memory. The client application 130 is generally capable of generating database queries. Once the client application 130 generates a query, the query may be submitted to a server (e.g., DBMS 180) for execution, using the network 150. The operating system 132 may be any operating system capable of performing the functions described herein.

The database server 170 contains a computer processor 172, storage media 174, I/O devices 176, memory 178 and a network interface 186. Computer processor 172 may be any processor capable of performing the functions described herein. As shown, storage media 174 contains data pages 175. The data pages 175 generally contain one or more rows of data. In one embodiment of the invention, data contained in the data pages 175 is associated with one or more key values in the database 184. I/O devices 226 may represent a variety of input and output devices, including keyboards, mice, visual displays, printers and so on. The database server 170 may connect to the network 150 using the network interface card 186. Furthermore, as will be understood by one of ordinary skill in the art, any computer system capable of performing the functions described herein may be used.

In the pictured embodiment, memory 178 contains a performance management component 180, a database management system 181 (hereinafter “DBMS”) and an operating system 185. Although memory 178 is shown as a single entity, memory 178 may include one or more memory devices having blocks of memory associated with physical addresses, such as random access memory (RAM), read only memory (ROM), flash memory or other types of volatile and/or non-volatile memory. The performance management component 180 generally controls the usage of additional performance capabilities of the system resources (e.g., the computer processor 172, hard disks 174, etc.) of the query governor system 170. As an example, the performance management component 180 may be configured to increase the operating frequency of the computer processor 172 for a limited amount of time. The DBMS 181 contains a query governor 182 and a database 184. The operating system 185 may be any operating system capable of performing the functions described herein.

As discussed above, when the DBMS 181 receives a query for processing, the query governor 182 may calculate an estimated execution time for processing the query. The query governor 182 may then determine a maximum allowable runtime for the received query. In one embodiment, the maximum allowable runtime is specified as part of the query. In another embodiment, the maximum allowable runtime is specified in a configuration file. The query governor 182 may then determine whether the estimated execution time exceeds the maximum allowable runtime, and if so, may calculate a second estimated execution time for the query, which approximates how long the query would take to execute if additional performance capabilities of the system resources are enabled. If the second estimated execution time does not exceed the maximum allowable runtime, the query governor 182 may instruct the performance management component 180 to use the additional performance capabilities of the existing system resources for the purposes of executing the query. The DBMS 181 may then execute the query against the database 184 to produce a set of query results, and return the set of query results to the requesting entity from which the query was received.

In one embodiment, the query governor 182 instructs the performance management component 180 to increase performance capabilities of the system resources so that the actual execution time of the query is at or near the maximum allowable runtime for the query. By doing this, embodiments may ensure that the query executes in an acceptable amount of time, while minimizing the power-usage and thermal impact from processing the query. As discussed above, system resources operating with additional performance capabilities may often consume more power and produce more heat, since often times such resources are operating at a higher frequency. Thus, by increasing the performance capabilities of the system resources so that the execution time of the query is at or near the maximum allowable runtime, embodiments may minimize the impact of the additional performance on the database system while still ensuring that queries execute in an acceptable amount of time.

In one embodiment, the query governor 182 may consider other factors when determining the maximum allowable runtime for the query. Such factors may include, without limitation, the origin of the query (i.e., the entity who submitted the query), a priority value associated with the query, and a class of the query. For instance, assume that there are two applications which submit queries to the DBMS 181: a mission-critical real-time application with a high priority value and a logging application for collecting database statistics with a low priority value. In such an example, the query governor 182 may assign a lower maximum allowable runtime to queries received from the mission-critical application than for queries received from the logging application. Thus, by setting a lower maximum allowable runtime for the processing of queries received from higher-priority application, the query governor 182 may ensure that these queries are processed more quickly.

Additionally, the query governor 182 may be configured to use additional performance capabilities of the existing resources only when processing queries received from the higher-priority mission-critical application and accordingly to expedite the processing of these queries. At the same time, the query governor 182 may set a higher maximum allowable runtime for the processing of queries received from the lower-priority application, and may avoid using the additional processing capabilities of the system resources in executing these queries. That is, because the additional processing capabilities are often unsustainable for the query governor system 170, the query governor 182 may be configured to only use such capabilities when processing high-priority queries. Of course, such examples are for without limitation and for illustrative purposes only, and one of ordinary skill in the art will recognize that any configuration of the query governor 182 consistent with the functions described herein may be used instead.

Furthermore, as discussed above, the query governor 182 may be configured to estimate an additional amount of energy that would be consumed in executing the query using the additional performance capabilities of the existing resources, relative to executing the query without using the additional performance capabilities. The query governor 182 may use the estimated additional amount of energy consumption in determining whether to execute the query using the additional performance capabilities of the resources. For instance, if the query governor 182 determines that the query could be executed within the threshold amount of time using the additional performance capabilities of the system resources, but that such additional performance capabilities would consume an excessive amount of energy, the query governor 182 may determine that the additional performance capabilities should not be used in processing the query. In such a scenario, the query governor 182 may take an alternative action in processing the query, such as, without limitation, storing the query for processing at a subsequent time, sending the query to a second node of a distributed database system, or rejecting the query for processing altogether.

In one embodiment, the query governor 182 is configured to predict a likelihood that subsequent queries will require use of the additional performance capabilities in order to execute within the threshold amount of time. The query governor 182 may use the likelihood in determining whether to use the additional performance capabilities for processing a current query. For instance, assume at 4:59 pm the query governor 182 receives a query for which the additional performance capabilities of the system resources are needed to process the query within the threshold amount of time. However, if the query governor 182 determines that one or more other queries are often received at 5:00 pm which typically require the additional performance capabilities of the system resources as well, the query governor 182 may refrain from using the additional performance capabilities in processing the current query, so that the additional performance capabilities will be available for processing subsequent queries.

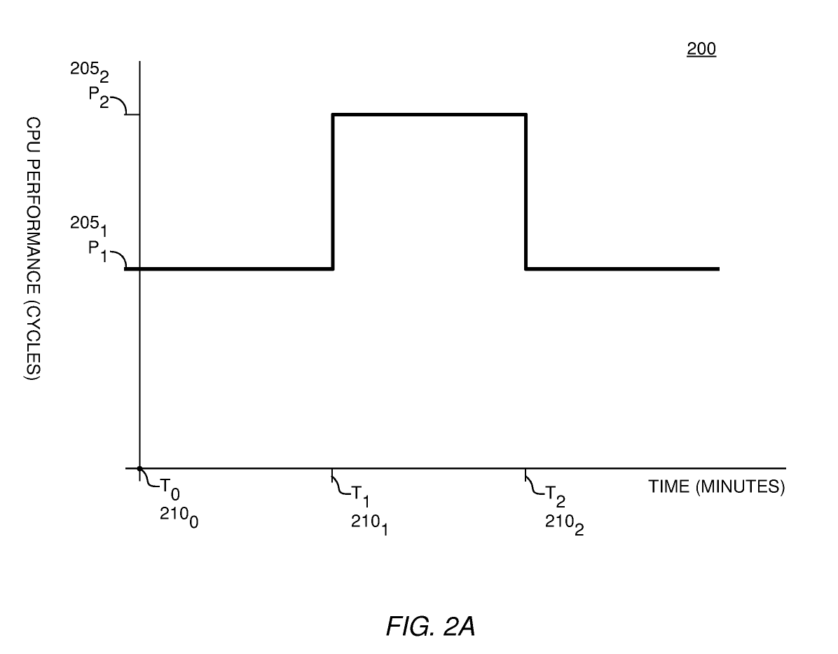

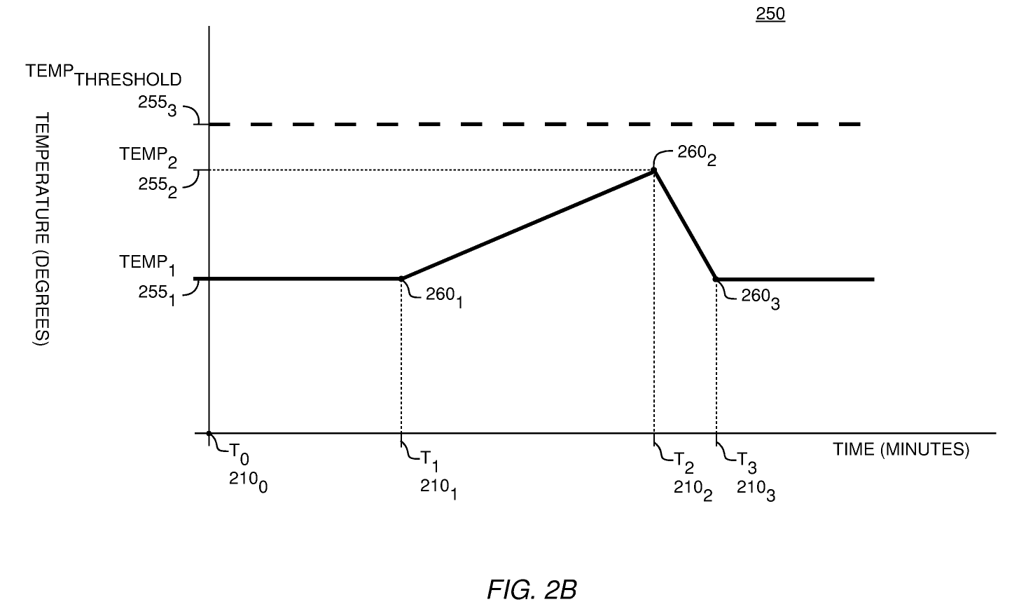

FIGS. 2A-2B are graphs illustrating the effects of using additional performance capabilities from a set of system resources, according to embodiments of the present invention. FIG. 2A is a graph illustrating the performance of a computer processor over time, according to one embodiment of the present invention. For the purposes of this example, assume that the computer processor may sustainably operate at P₁ cycles, without any heating or power consumption issues. As shown, the graph 200 illustrates the computer processor operating at the sustainable rate of P₁ cycles 205₁ from the time T₀ 210₀ to the time T₁ 210₁. At time T₁ 210₁ until time T₂ 210₂, the performance is increased to the rate of P₂ 205₂ cycles. At time T₂ 210₂, the clock cycles then decrease back to the sustainable rate of P₁ cycles 205₁. Thus, although the computer processor is capable of operating at a higher level of performance (i.e., with clock cycles of P₂ 205₂), such additional performance is not sustainable and the computer processor may only operate at such levels of performance for a limited period of time.

Thermal considerations are one factor which may limit the cycle rate of the computer processor. FIG. 2B is a graph illustrating the temperature of the computer processor over time, according to one embodiment of the present invention. For purposes of this example, assume that the temperature Temp_{threshold} represents the maximum temperature that the computer processor may operate at without overheating. As shown, the graph 250 illustrates the computer processor operating at temperature Temp₁ 255₁ from time T₀ 210₀ until time T₁ 210₁. At point 260₁, the temperature begins to increase, reaching a peak temperature of Temp₂ 255₂ degrees at time T₂ 210₂. This peak is shown as the point 260₂. After the point 260₂, the temperature begins to decrease until the point 260₃, where the computer processor again reaches the temperature Temp₁ 255₁ at the time T₃ 210₃.

Thus, when the computer processor is operating at the increased cycle rate of P₂ cycles 205₂ during the time period of time T₁ 210₁ to time T₂ 210₂, the temperature of the computer processor gradually increases. Accordingly, the cycle rate of P₂ cycles 205₂ is not a sustainable rate for the computer processor, since the temperature of the computer processor would reach the temperature Temp_{threshold} shortly after the time T₂ 210₂, if the cycle rate of P₂ cycles 205₂ was maintained. In other words, the cycle rate of P₂ cycles 205₂ is not a sustainable operating rate for the computer processor in this example because the computer processor would overheat after operating at that rate for a period of time.

Although such additional performance capabilities of the computer processor are not sustainable, this additional performance may still be used for limited periods of time. As described above, embodiments of the invention may provide a query governor configured to use additional performance capabilities of existing system resources in order to manage query execution. Thus, although the query governor may determine that a particular query may normally not be executed within a threshold amount of time, the query governor may further determine that the query could be executed within the threshold amount of time if additional performance capabilities of the system resources were used. In such a scenario, the DBMS may process the query using the additional performance capabilities of the system resources (e.g., using a higher cycle rate for the computer processor). Advantageously, by doing this, embodiments of the invention help to ensure that queries may be processed by the DBMS within an acceptable amount of time.

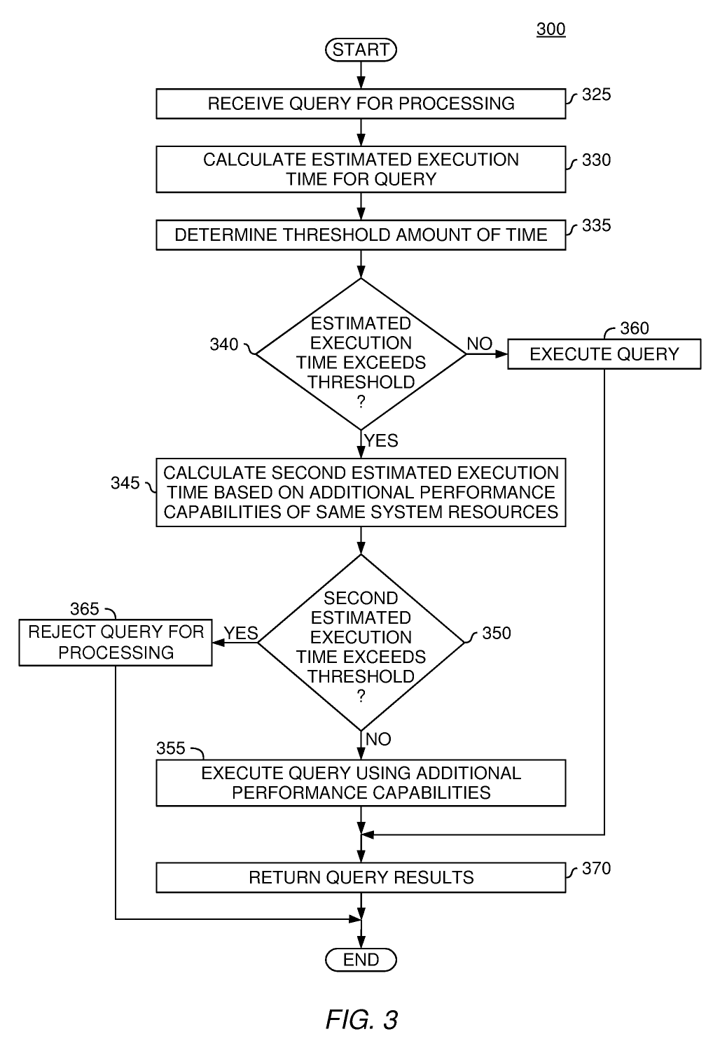

FIG. 3 is a flow diagram illustrating a method for managing query runtime, according to one embodiment of the present invention. As shown, the method 300 begins at step 325, where the DBMS 181 receives a query for processing. Upon receiving the query, the query governor 182 calculates an estimated execution time for processing the query (step 330). Of note, the estimated execution time calculated in step 330 approximates the amount of time that the query will take to execute if no additional performance capabilities from the system resources are used. The estimated execution time may be calculated based on historical data collected from the processing of previous queries. That is, the query governor 182 may calculate the estimated execution time for a current query by identifying previously-executed queries that were similar to the current query and by determining how long the previously-executed queries took to execute.

Once the estimated execution time for the query is calculated, the query governor 182 determines a threshold amount of time for the query (step 335). As discussed above, the threshold amount of time generally refers to a maximum allowable runtime the received query should finish executing within. In one embodiment, the threshold amount of time may be specified (e.g., by the requesting entity) in the received query. In such an embodiment, the threshold amount of time may be defined using one or more SQL tags in the received query. In another embodiment, the threshold amount of time may be defined in a configuration file (e.g., in storage 174 on the query governor 170).

Additionally, the query governor 182 may determine the threshold amount of time based on an origin, priority level and/or class of the query. For example, assume a particular DBMS receives queries that may be classified as either high priority, medium priority or low priority. For instance, the DBMS may receive queries from two different software applications: a mission-critical real-time application with a high priority value and a logging application for collecting database statistics with a low priority value. In any event, if the query governor 182 determines a particular received query is a high priority query, the query governor 182 may assign a relatively low threshold amount of time to the query. That is, because the query is of high importance, the query should generally be processed in a short amount of time. As a second example, if the query governor 182 determines a second received query is a low priority query, the query governor 182 may assign a relatively high threshold amount of time to the second query. That is, since the query is of low priority, it may be less important to process the query in a short amount of time, as compared to the processing of the high priority query. Furthermore, in one embodiment, the threshold amount of time is specified as a flat amount of time (e.g., 60 seconds). In another embodiment, the threshold amount of time is determined using an execution time adjustment threshold, which specifies a maximum percentage that the estimated execution time may be increased (e.g., 20%).

Once the threshold amount of time is determined, the query governor 182 determines whether the estimated execution time exceeds the threshold amount of time (step 340). If the estimated execution time does not exceed the threshold, the DBMS 181 executes the query (step 360) and returns the results produced by executing the query to the requesting entity who submitted the query (step 370). Once the query results are returned, the method 300 ends.

If, instead, the query governor 182 determines that the estimated execution time exceeds the threshold amount of time, the query governor 182 then calculates a second estimated execution time (step 345). The second estimated execution time approximates the amount of time the query will take to execute if the additional performance capabilities of the system resources are used. As discussed above, one example of such additional performance may include increasing the cycle rate of one or more computer processors for a limited amount of time.

The query governor 182 then determines whether the second estimated execution time exceeds the threshold amount of time (step 350). In other words, the query governor 182 determines whether the query may be executed within an acceptable of time if the additional performance capabilities of the system resources are used. If the query governor 182 determines the second estimated execution time does not exceed the threshold, the query governor 182 instructs the performance management component 180 to use additional performance capabilities when the query is executed. Once the additional performance capabilities are enabled, the DBMS 181 executes the query (step 355). Upon executing the query, the DBMS 181 then returns the query results produced from executing the query to the requesting entity, and the method 300 ends.

In one embodiment of the invention using a distributed database system, upon determining that the second estimated execution time does not exceed the threshold amount of time, the query governor 182 may determine whether another database node in the distributed database system is better suited to process the query. That is, as discussed above, the additional performance capabilities of a system resource may often only be used for a limited amount of time. For instance, while a processor may be capable of operating at a higher clock rate for a short period of time, such additional performance may not be sustained due to overheating concerns. Thus, if the query governor 182 determines that its system resources have been operating recently using additional performance capabilities, while another database node in the distributed database system has not used any additional performance capabilities recently, the query governor 182 may transmit the query to the other database node for processing. Advantageously, by doing this, embodiments of the invention may effectively distribute the heating and power costs of using the additional performance capabilities between multiple nodes in the distributed database system.

Furthermore, in one embodiment, the query governor 182 may further consider a likelihood that subsequent queries will need to use the additional performance capabilities in order to complete within an acceptable amount of time. Thus, as an example, the query governor 182 may determine that at 5:00 pm each day, the DBMS 181 receives a substantial number of high-priority queries, and that many of these high-priority queries rely on the additional performance capabilities of the system resources in order to complete in an acceptable amount of time. Accordingly, if the query governor 182 determines that a low-priority query received at 4:59 pm will require the additional performance capabilities in order to execute within an acceptable period of time, the query governor 182 may nonetheless reject the query for processing in order to preserve the additional performance capabilities for the high-priority queries that will likely be received at 5:00 pm. Advantageously, by doing this, embodiments of the invention may conserve the additional performance capabilities of the system resources for processing the most important queries.

If, at step 350, the query governor 182 determines that the second estimated execution time also exceeds the threshold amount of time, the query governor 182 may reject the query for processing (step 365), and the method 300 ends. In one embodiment, rather than rejecting the query for processing, the query governor 182 may store the query for processing at a later moment in time. For instance, the query governor 182 may store the query until the resources of the database system are idle. That is, in a situation where the system resources are idle and are not otherwise being used, it may be acceptable to process a query whose execution time exceeds the threshold amount of time, because such actions are unlikely to affect the execution of other queries on the database system.

In another embodiment, upon determining that the second estimated execution time also exceeds the threshold amount of time, the query governor 182 may send the query to another database system for processing. That is, in a distributed database environment, there may be multiple database systems which each contain a separate instance of the database. In such an environment, the query governor 182 may transmit the query to another system where the query may be processed. As an example, a distributed database environment may include a primary database system responsible for processing high priority queries in a short amount of time, and a second database system responsible for processing the remaining queries. Continuing the example, if the query governor 182 on the primary database system determines that a particular query cannot execute within an acceptable amount of time, even when using the additional performance capabilities of the system resources, the query governor 182 on the primary database system may send the particular query to the secondary database system for processing. Of course, the above examples are without limitation and for illustrative purposes only, and one of ordinary skill in the art will realize that any system configuration consistent with the functions described herein may be used instead.

In yet another embodiment, the query governor 182 may further consider an estimated amount of energy consumed in executing the query using the additional performance capabilities of the system resources. Generally, although system resources are often capable of producing additional performance for limited periods of time, such additional performance often results in increased energy consumption. For example, although a particular processor may be operating at an over-clocked cycle rate, such additional performance may require additional energy consumption. Accordingly, the query governor 182 may calculate an estimated energy consumption value for executing the query using the additional performance capabilities. The query governor 182 may then determine whether to execute the query using the additional performance capabilities or to take an alternate course of action (e.g., reject the query for processing, send the query to another database system for processing, etc.) based on the calculated energy consumption value.

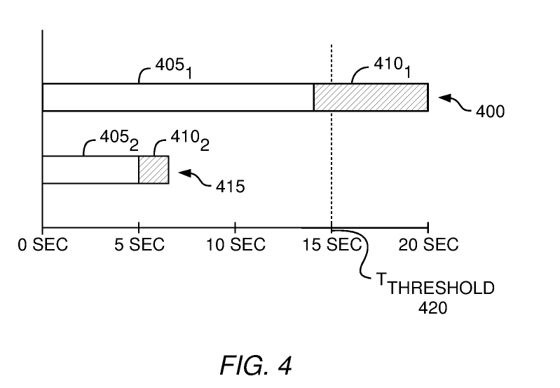

FIG. 4 is a timeline diagram illustrating the effects of using additional performance capabilities from a set of system resources on query runtime, according to one embodiment of the present invention. For purposes of the examples described below, assume that T_{threshold} represents a threshold amount of time which queries must finish executing within. As shown, the timeline 400 represents a first query which is estimated to take 20 seconds to finish executing. The un-shaded portion 405₁ represents the estimated amount of time that the first query will take to execute using additional performance capabilities of the system resources. Thus, as shown, the query governor 182 has determined that the first query will take 14 seconds to execute if the additional performance capabilities of the system resources are used. Likewise, the shaded portion 410₁ represents the amount of time that may be saved by using the additional performance capabilities of the system resources (i.e., 6 seconds). In this example, the original estimated time to execute the query without using any additional performance capabilities (i.e., 20 seconds) exceeded the threshold amount of time T_{threshold} 420 (i.e., 15 seconds). Furthermore, because the query governor 182 has determined that, if the additional performance capabilities of the system resources are used, the query will finish executing within 14 seconds, the query governor 182 will instruct the performance management component 180 to use additional performance capabilities of the system resources when the DBMS 181 processes the query. Advantageously, by doing this, embodiments of the invention ensure that the first query will finish processing within an acceptable amount of time. Additionally, embodiments more efficiently utilize the system resources by taking advantage of the additional performance capabilities of the system resources for limited periods of time.

The timeline 415 represents the estimated execution time for a second query. As shown, the second query is estimated to take 6 seconds to process if no additional performance capabilities are used. The un-shaded portion 405₂ represents the amount of time the query will take to execute using additional performance capabilities of the system resources. Thus, as shown, the query governor 182 has determined that the first query will take 5 seconds to execute if the additional performance capabilities of the system resources are used. Likewise, the shaded portion 410₂ represents the amount of time that may be saved by using the additional performance capabilities of the system resources (i.e., 1 second). Thus, in this example, because the query governor 182 has determined that the second query can execute within the threshold amount of time T_{threshold} 420 even if no additional performance capabilities of the system resources are used, the query governor 182 will instruct the performance management component 180 not to use additional performance capabilities when the second query is processed. That is, because the additional levels of performance from the system resources are not sustainable, the query governor 182 may avoid using such capabilities for queries which may ordinarily be executed within the threshold amount of time. By doing this, embodiments of the invention may ensure that the additional performance capabilities of the system resources will be available for processing queries whose processing time would otherwise exceed the threshold amount of time.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A computer-implemented method for managing query execution, comprising:
calculating, by operation of one or more computer processors, a first estimated execution time for processing a query using a first amount of performance capabilities from a first set of system resources;
upon determining that the first estimated execution time exceeds a threshold amount of time, calculating a second estimated execution time for processing the query using a second amount of performance capabilities from the first set of system resources, wherein the second amount performance capabilities is in addition to the first amount of performance capabilities;
upon determining that the second estimated execution time does not exceed the threshold amount of time, executing the query using the second amount of performance capabilities from the first set of system resources.

2. The computer-implemented method of claim 1, further comprising:
upon determining that the first estimated execution time does not exceed the threshold amount of time, executing the query using the first set of system resources using the first amount of performance capabilities from the first set of system resources.

3. The computer-implemented method of claim 1, further comprising:
upon determining that the second estimated execution time exceeds the threshold amount of time, rejecting the query for processing.

4. The computer-implemented method of claim 1, further comprising:
upon determining that the second estimated execution time exceeds the threshold amount of time, storing the query for processing at a subsequent point in time.

5. The computer-implemented method of claim 1, further comprising:
upon determining that the second estimated execution time exceeds the threshold amount of time, determining a likelihood that a subsequent workload will need the second amount of performance capabilities from the first set of system resources within a predetermined amount of time; and
based on the determined likelihood, performing at least one of:
rejecting the query for processing;
storing the query for processing at a subsequent point in time; and
transmitting the query to another system for processing.

6. The computer-implemented method of claim 1, wherein the threshold amount of time is based on at least one of (i) the requesting entity, (ii) a priority level associated with the received query, and (iii) historical workload data describing a usage of the first set of system resources.

7. The computer-implemented method of claim 1, further comprising:
identifying a system in a distributed database group where the query can be processed in an amount of time that does not exceed the threshold amount of time; and
transmitting the query to the identified system in the distributed database group for processing.

8. The computer-implemented method of claim 1, further comprising:
estimating an amount of energy consumption for processing the query using the second amount of performance capabilities of the first set of system resources; and
wherein the query is executed using the second amount of performance capabilities from the first set of system resources upon further determining that the estimated amount of energy consumption does not exceed a threshold amount of energy.

9. A system, comprising:
a computer processor; and
a memory containing a program that, when executed by the computer processor, performs an operation for managing query execution, comprising:
calculating a first estimated execution time for processing a query using a first amount of performance capabilities from a first set of system resources;
upon determining that the first estimated execution time exceeds a threshold amount of time, calculating a second estimated execution time for processing the query using a second amount of performance capabilities from the first set of system resources, wherein the second amount performance capabilities is in addition to the first amount of performance capabilities;
upon determining that the second estimated execution time does not exceed the threshold amount of time, executing the query using the second amount of performance capabilities from the first set of system resources.

10. The system of claim 9, the operation further comprising:
upon determining that the first estimated execution time does not exceed the threshold amount of time, executing the query using the first set of system resources using the first amount of performance capabilities from the first set of system resources.

11. The system of claim 9, the operation further comprising:
upon determining that the second estimated execution time exceeds the threshold amount of time, rejecting the query for processing.

12. The system of claim 9, the operation further comprising:
upon determining that the second estimated execution time exceeds the threshold amount of time, storing the query for processing at a subsequent point in time.

13. The system of claim 9, the operation further comprising:
upon determining that the second estimated execution time exceeds the threshold amount of time, determining a likelihood that a subsequent workload will need the second amount of performance capabilities from the first set of system resources within a predetermined amount of time; and
based on the determined likelihood, performing at least one of:
rejecting the query for processing;
storing the query for processing at a subsequent point in time; and
transmitting the query to another system for processing.

14. The system of claim 9, wherein the threshold amount of time is based on at least one of (i) the requesting entity, (ii) a priority level associated with the received query, and (iii) historical workload data describing a usage of the first set of system resources.

15. The system of claim 9, the operation further comprising:
identifying a system in a distributed database group where the query can be processed in an amount of time that does not exceed the threshold amount of time; and
transmitting the query to the identified system in the distributed database group for processing.

16. The system of claim 9, the operation further comprising:
estimating an amount of energy consumption for processing the query using the second amount of performance capabilities of the first set of system resources; and
wherein the query is executed using the second amount of performance capabilities from the first set of system resources upon further determining that the estimated amount of energy consumption does not exceed a threshold amount of energy.

17. A computer program product for managing query execution, comprising:
a computer-readable storage medium having computer readable program code embodied therewith, the computer readable program code comprising:
computer readable program code to calculate a first estimated execution time for processing a query using a first amount of performance capabilities from a first set of system resources;
computer readable program code to, upon determining that the first estimated execution time exceeds a threshold amount of time, calculate a second estimated execution time for processing the query using a second amount of performance capabilities from the first set of system resources, wherein the second amount performance capabilities is in addition to the first amount of performance capabilities;
computer readable program code to, upon determining that the second estimated execution time does not exceed the threshold amount of time, execute the query using the second amount of performance capabilities from the first set of system resources.

18. The computer program product of claim 17, further comprising:
computer readable program code to, upon determining that the first estimated execution time does not exceed the threshold amount of time, execute the query using the first set of system resources using the first amount of performance capabilities from the first set of system resources.

19. The computer program product of claim 17, further comprising:
computer readable program code to, upon determining that the second estimated execution time exceeds the threshold amount of time, determine a likelihood that a subsequent workload will need the second amount of performance capabilities from the first set of system resources within a predetermined amount of time; and
computer readable program code to, based on the determined likelihood, at least one of:
reject the query for processing;
store the query for processing at a subsequent point in time; and
transmit the query to another system for processing.

20. The computer program product of claim 17, further comprising:
computer readable program code to identify a system in a distributed database group where the query can be processed in an amount of time that does not exceed the threshold amount of time; and
computer readable program code to transmit the query to the identified system in the distributed database group for processing.
